(19) United States
(12) Patent Application Publication
(10) Pub. No.: US 2018/0093758 A1
(43) Pub. Date: Apr. 5, 2018

(54) LOAD ALLEVIATION OF A STRUCTURE IN A FLUID FLOW

(71) Applicant: AIRBUS GROUP INDIA PRIVATE LIMITED, Bangalore (IN)

(72) Inventors: ANGSHU CHATTERJEE, Bangalore (IN); ARUN SHOURIE RAJANGAM, Bangalore (IN)

(21) Appl. No.: 15/715,194

(22) Filed: Sep. 26, 2017

(30) Foreign Application Priority Data
Sep. 30, 2016 (IN) 201641033436

(51) Int. Cl. B64C 21/08; B64C 3/00

(52) U.S. Cl. CPC B64C 21/08; B64C 3/00

(57) ABSTRACT

In one example, a structure in a fluid flow is disclosed, which may include a first surface defining at least one slot, a second surface facing opposite to the first surface and defining at least one slot, and at least one first channel defining a fluid flow path between the at least one slot in the first surface and the at least one slot in the second surface. Further, the structure may include a pressure sensing and control unit coupled to the at least one first channel. The pressure sensing and control unit may include a pressure sensor to determine a differential pressure between the first surface and the second surface, and a controller to control fluid flow through the at least one first channel based on the differential pressure.

### RELATED APPLICATION

Benefit is claimed under 35 U.S.C. 119(a)-(d) to Foreign Application Serial No. 201641033436 filed in India entitled “LOAD ALLEVIATION OF A STRUCTURE IN A FLUID FLOW”, filed on Sep. 30, 2016 by AIRBUS GROUP INDIA PRIVATE LIMITED which is herein incorporated in its entirety by reference for all purposes.

### BACKGROUND

Load alleviation may be used to reduce bending moments at roots of wing structures. Reducing the bending moments, in turn, may enable wing structure weight to be reduced. A reduction in wing structure weight is desirable, as it may reduce fuel costs and other aircraft operating costs. A load alleviation function may permit to alleviate the wing structure loads. During flight, the load alleviation function may be achieved either through the deflection (e.g., upward) of the two ailerons disposed on the wing or through the deflection of the two ailerons along with the spoilers disposed on the wing.

### SUMMARY

In one aspect, a structure in a fluid flow, may include a first surface defining at least one slot, a second surface facing opposite to the first surface and defining at least one slot, at least one first channel defining a fluid flow path between the at least one slot in the first surface and the at least one slot in the second surface, and a pressure sensing and control unit coupled to the at least one first channel. The pressure sensing and control unit may include a pressure sensor to determine a differential pressure between the first surface and the second surface during operation of the structure (i.e., subjected to the fluid flow) and a controller to control fluid flow through the at least one first channel based on the differential pressure.

In another aspect, a method for controlling load of a structure in a fluid flow is disclosed. At least one first fluid flow path may be defined between a first set of slots provided on a top surface of a structure and a second set of slots provided on a bottom surface of the structure. Further, differential pressure between the top surface and the bottom surface is determined. Furthermore, fluid flow through the at least one first fluid flow path may be controlled to reduce load on the structure based on the differential pressure.

In yet another aspect, an aerodynamic component load alleviation system may include a wing that is divided into a plurality of zones along a span of the wing. Each zone may include a top surface having a first set of slots distributed across a chord, a bottom surface having a second set of slots distributed across the chord, and at least one first channel defining an air flow path between the first set of slots and the second set of slots. Each zone may further include a pressure sensor to determine a differential pressure between the top surface and the bottom surface during flight and a controller to control air flow through the at least one first channel based on the differential pressure, thereby controlling the pressure across the span (and hence the loading) as per the design of the wing.

### BRIEF DESCRIPTION OF THE DRAWINGS

Examples are described in the following detailed description and in reference to the drawings, in which:

FIG. 1 is a cross sectional view of an example structure depicting components to control pressure difference between a top surface and a bottom surface;

FIG. 2 is a cross sectional view of the example structure of FIG. 1, depicting additional components;

FIG. 3 is a top view of an example aerodynamic component load alleviation system in which a wing is partitioned into a plurality of zones;

FIG. 4 is a top view of the example aerodynamic component load alleviation system of FIG. 3, depicting pressure sensing and controlling slots and non-pressure sensing slots in each zone;

FIG. 5 is an example graph showing differential pressure on the Y-axis and length of a structure on the X-axis, with curves illustrating differential pressure distribution of a structure with and without load alleviation function; and

FIG. 6 is a flowchart of an example method for controlling load of a structure.

### DETAILED DESCRIPTION

The following examples describe a method and system for controlling load of a structure in a fluid flow. For example, when an aircraft performs a turn or the aircraft wing is subject to a gust of wind, the wing load is momentarily increased, thus increasing the bending moment on the wing. This results in an increase in the load on the wings and may lead to a catastrophic structural failure. In such cases, the ailerons and/or spoilers may be deflected to alleviate the load on the wings during turbulence. Spoilers may be used to reduce lift of the wing and to slightly increase the drag of the wing.

In some examples, root bending moments may be reduced by unloading aerodynamic lift at tips of the wing structure. In passive load alleviation, wing flexibility in swept-back wings may be used as a means to bring the center of pressure more inboard, hence reducing the wing root bending moment. In such cases, wing structures of an aircraft may be designed with a combination of high aft sweep and sufficient flexure to reduce wing tip angle of attack. Such passive load alleviation may be generally lighter and less complex than active load alleviation. Active load alleviation may include actuators, flaps and other flight control mechanisms that add complexity and weight to the aircraft. In some other examples, micro-slots may be used to create suction or blowing effects on the aerofoil surface, in order to control the boundary layer. The micro-slots may be actively controlled, or passively controlled.

Examples described herein may provide a structure. The structure may include a first surface defining a first set of slots, a second surface facing opposite to the first surface and defining a second set of slots, and channels defining fluid flow path between the first set of slots and the second set of slots. Example slots may include micro slots. For example, in wing the micro slots may be distributed across a chord on both upper and lower surfaces of particular section of the wing, located at different locations across the span. Further, the structure may include a pressure sensing and control unit coupled to the channels. The pressure sensing and control unit may include a pressure sensor and a controller coupled to the pressure sensor. During operation (e.g., of the vehicle or structure subjected to the fluid flow), the pressure sensor may determine a differential pressure between the first surface and the second surface (e.g., through the slots defined in the first surface and the second surface), and the controller may control fluid flow through the channels based on the differential pressure.

In one example, the controller may determine whether the differential pressure between the first surface and the second surface of the aerofoil exceeds a pre-determined limit. In one example, the pre-determined limit (e.g., maximum threshold value) is pre-programmed into the pressure sensor, for instance, using calibration techniques. When the differential pressure between the first surface and the second surface exceeds the pre-determined limit, the controller may command a control valve (e.g., defined in the channel) to allow the fluid flow through the at least one channel between the first surface and the second surface, thereby reducing pressure difference between the first surface and the second surface. When the differential pressure between the first surface and the second surface falls below the pre-determined limit, the controller may command the control valve to stop the fluid flow through the at least one first channel. The extent of opening of the control valve may be a function of different pressure differentials with respect to the threshold value.

Examples described herein may reduce structure (e.g., wing) root bending moment in critical load conditions without using any control surfaces or a closed-loop control system. Examples described herein may replace the traditional load alleviation functions, for instance, scheduled via an electronic flight control system in case of aircraft encountering gust, with an independent mechanical control unit (e.g., mechanically scheduled loads alleviation function (MSLAF)). The control unit/MSLAF may be standalone, mechanical system, independent of the flight controls, and may therefore immune to control law degradations. The channels defined between the slots on the top surface and the slots on the bottom surface may be flexible, and can be routed through the available space without disrupting the existing systems, fuel tanks, and the like, in the wing.

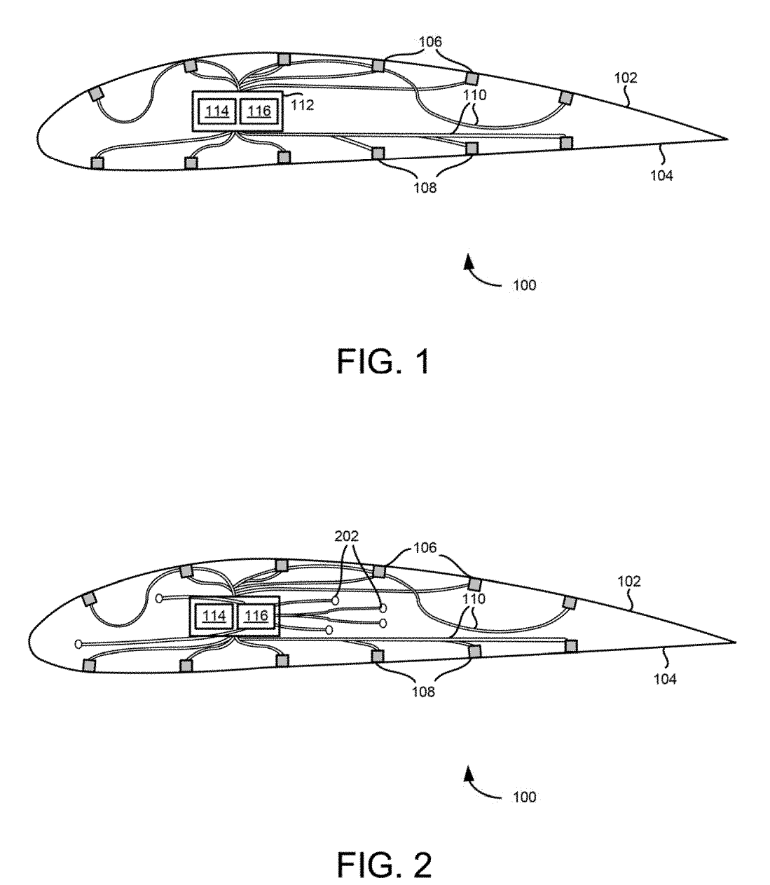

FIG. 1 is a cross sectional view of an example structure 100 depicting components to control pressure difference between a first surface 102 (e.g., top surface) and a second surface 104 (e.g., bottom surface). The structure 100 may provide load alleviation function during operation of a vehicle or constructions when placed in a fluid flow. For example, the load alleviation function may permit to alleviate the load on the structure 100. Example vehicle may be a flying vehicle (e.g., an aircraft, a spacecraft, a missile, or the like), a watercraft (e.g., cruise, ship, or the like), and road vehicle (e.g., a car). Example structure 100 may include, but not limited to, aerodynamic component of a vehicle such as wing, spoiler, stabilizing surface, control surface of the aircraft, a high-rise structure such as a tower, sky-scraper, other aerodynamic component such as blades of a windmill, column or pillars of partly or completely immersed structures like oil rigs, spoiler for a car, and the like. For example, the spoiler may be an automotive aerodynamic device whose intended design function is to ‘spoil’ unfavorable air movement across a body of the vehicle in motion. The spoilers may be used in vehicles such as cars and boats.

The structure 100 may include a first surface 102 and a second surface 104 facing opposite to the first surface 102. The first surface 102 may include slots 106 and the second surface 104 may include slots 108. Example slots 106 and 108 may be micro-slots. Further, the structure 100 may include channels 110 formed between the slots 106 and the slots 108. In other words, the micro-slots on the top surface and the bottom surface are connected through a channel. As shown in FIG. 1, the channels 110 may define fluid flow path between the slots 106 on top surface 102 and the slots 108 on the bottom surface 104. The slots 106 in the first surface 102 and the slots 108 in the second surface 104 may positioned in line with openings of the respective one of the channels 110. The channels 110 may be disposed within the available space of the structure 100 without disrupting the existing systems, fuel tanks, and the like, in the structure 100.

Furthermore, the structure 100 may include a pressure sensing and control unit 112 coupled to the channels 110. In one example, the channels 110 may be formed between the slots 106 and the slots 108 through the pressure sensing and control unit 112. The pressure sensing and control unit 112 may include a pressure sensor 114 and a controller 116. The pressure sensor 114 may be pre-programmed with a pre-determined limit, for instance, using calibration techniques.

In operation, the pressure sensor 114 may determine a differential pressure between the first surface 102 and the second surface 104 during movement of the structure or when the structure is subjected to a fluid flow. The pressure sensor 114 may determine the differential pressure between the first surface 102 and the second surface 104 using the slots 106 and the 108 defined in each of the first surface 102 and the second surface 104. The controller 116 may control fluid flow through the channels 110 based on the differential pressure. For example, a channel may include a control valve which controls the fluid flow through the channel between the micro slots on the top and bottom surfaces.

In one example, the controller 116 may determine whether the differential pressure between the first surface and the second surface exceeds a pre-determined limit. When the differential pressure between the first surface 102 and the second surface 104 exceeds the pre-determined limit, the controller 116 may instruct a control valve to allow the fluid flow through the channels 110 between the first surface 102 and the second surface 104, thereby reducing pressure difference between the first surface 102 and the second surface 104. When the differential pressure between the first surface 102 and the second surface 104 falls below the pre-determined limit, the controller 116 may instruct the control valve to stop the fluid flow through the channels 110. Example control valves may be control flaps to open/close the slots 106 and 108 on each of the first surface 102 and the second surface 104. In another example, control valve may be implemented as part of the controller 116 or may reside on a surface controlling the size of the slots, for example, using a flap. In one example, the controller 116 may control the fluid flow through the channels 110 as a function of the differential pressure with respect to the pre-determined limit.

FIG. 2 is a cross sectional view of the example structure 100 of FIG. 1, depicting additional components. Particularly, FIG. 2 illustrates non-pressure sensing slots defined substantially adjacent to the slots 106 and 108 in the first surface 102 and the second surface 104, respectively. Further, the structure 100 may include channels 202 formed between the non-pressure sensing slots defined in the first surface 102 and the non-pressure sensing slots defined in the second surface 104. Further, the channels 202 may be coupled to the controller 116 and may not be coupled to the pressure sensor. In this case, the pressure sensor 114 may determine differential pressure between the top surface 102 and the bottom surface 104 at the slots 106 and 108. The controller may use the differential pressure measured between the slots 106 and 108 to control fluid flow through the channels 202 (i.e., formed between the non-pressure sensing slots in the top surface 102 and the bottom surface 104).

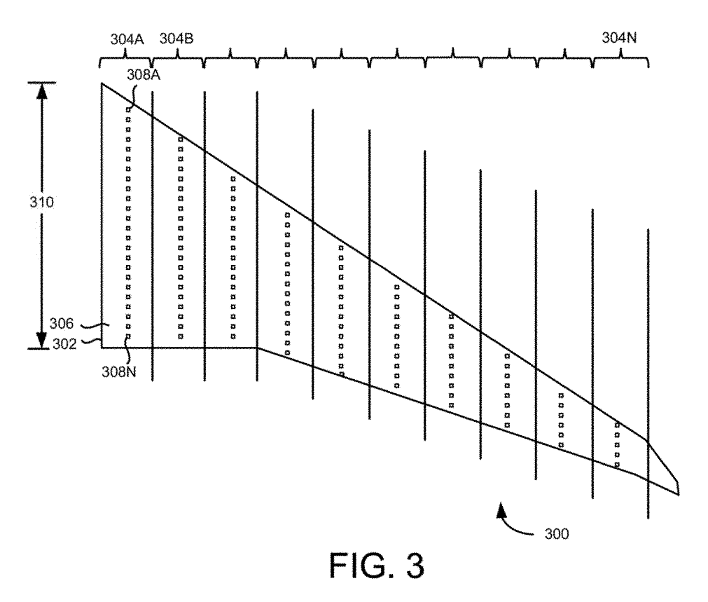

FIG. 3 is a top view of an example aerodynamic component load alleviation system 300 in which the wing 302 is partitioned into a plurality of zones 304A-N. In one example, the wing 302 may be divided into a plurality of zones 304A-N along a span of the wing 302. For example, a part of the wing 302 or whole wing 302 may be divided into the plurality of zones. The features and functionalities of each zone may be similar/correspond to the structure 100 of FIG. 1. The functions of each zone is explained in detail with respect to zone 304A. Each zone 304A (e.g., structure 100 as shown in FIG. 1) may include a top surface 306 having a first set of slots 308A-N distributed across a chord 310. Similarly, each zone 304A may include a bottom surface having a second set of slots (e.g., not shown in FIG. 3) distributed across the chord 310. The first set of slots and the second set of slots may be used to sense pressure, which can be used to control the fluid flow between the first set of slots and the second set of slots.

Further, each zone 304A may include a first set of channels defining an air flow path between the first set of slots and the second set of slots. Furthermore, each zone 304A may include a pressure sensor to determine a differential pressure between the top surface and the bottom surface during flight, and a controller to control air flow through the first set of channels based on the differential pressure. The controller may control the air flow through the first set of channels as a function of the differential pressure with respect to the pre-determined limit. In one example, the pressure sensor may be pre-programmed with the pre-determined limit that is tuned corresponding to each zone. For example, the pre-determined limit can be different for different zones and can be set for each zone using calibration techniques. Each zone may be controlled independently to achieve the desired bending moment of the wing.

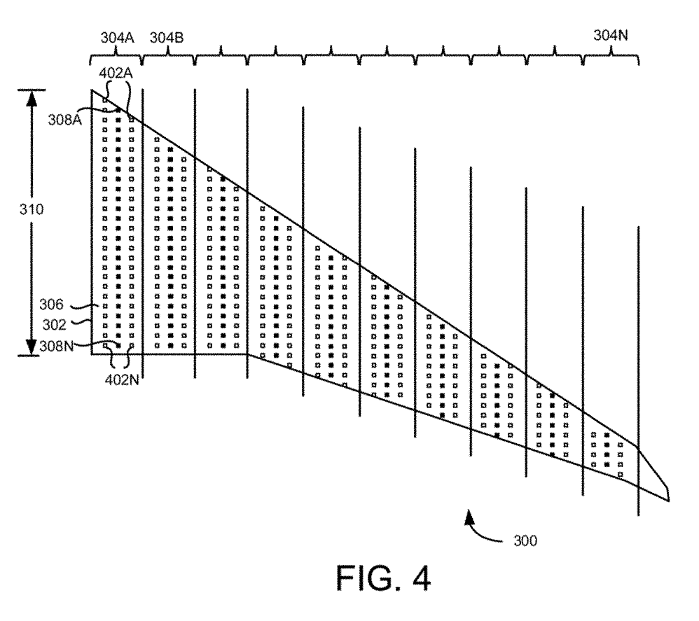

FIG. 4 is a top view of an example aerodynamic component load alleviation system 300 of FIG. 3, depicting pressure sensing and controlling slots and non-pressure sensing slots in each zone. The features and functionalities of each zone may be similar/correspond to the structure 100 of FIG. 2. In the example shown in FIG. 4, the top surface 306 may include a first set of non-pressure sensing slots 402A-N defined substantially adjacent to the first set of slots 308A-N. Similarly, the bottom surface (e.g., not shown in FIG. 4) may include a second set of non-pressure sensing slots defined substantially adjacent to the second set of slots on the bottom surface. The first set and the second set of non-pressure sensing slots may be distributed across the chord. Further, each zone may include a second set of channels formed between the first set of non-pressure sensing slots 402A-N and the second set of non-pressure sensing slots.

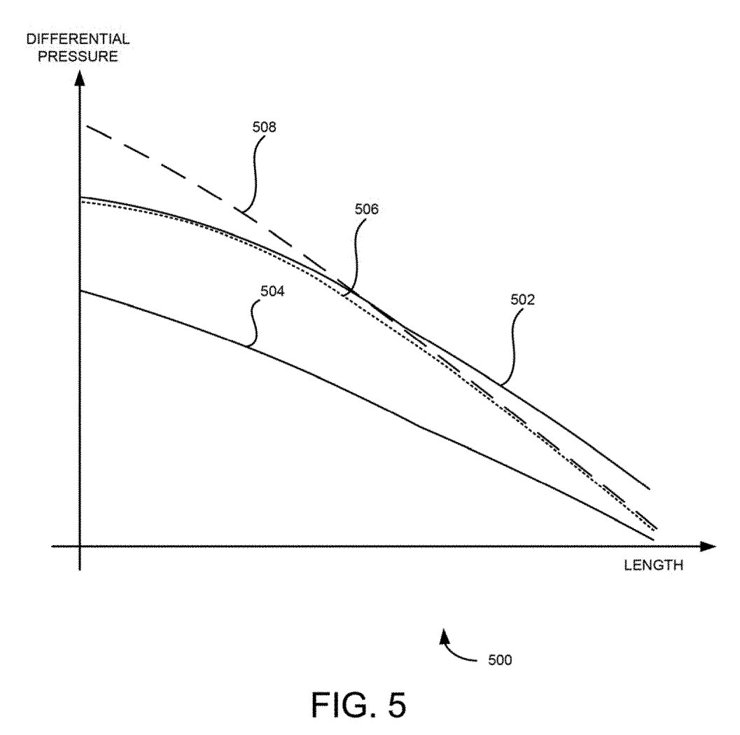

In one example, the second set of channels may be defined within the wing. Further, the first set of non-pressure sensing slots and the second set of non-pressure sensing slots are positioned in line with openings of the second set of channels. In one example, the controller may control air flow through the second set of channels based on the differential pressure determined between the first set of slots 308A-N and the second set of slots on the bottom surface. In this case, the non-pressure sensing slots may not require a separate pressure sensor, thereby reducing the number of sensors needed to control differential pressure for each zone. Even though FIGS. 4 and 5 depict a plurality of zones 304A-304N with each zone having pressure sensing slots and/or non-pressure sensing slots, the structure can also be implemented with some zones having pressure sensing slots and/or non-pressure sensing slots and remaining zones without any slots.

FIG. 5 is an example graph 500 showing differential pressure on the Y-axis and length of a structure on the X-axis, with curves illustrating differential pressure of a structure with and without load alleviation function. Particularly, FIG. 5 illustrates graph 502 depicting a pre-determined limit of differential pressure along the length of the structure based on design limitation. Further, graph 504 may depict desired pressure difference along the length of the structure during normal operations. Further, graph 506 may depict differential pressure along the length of the structure achieved using the load alleviation described in FIGS. 1-4. Furthermore, graph 508 may depict differential pressure along the length of the structure under undesirable conditions, for example, without using any load alleviation. As shown in FIG. 5, the differential pressure may go beyond the pre-determined limit 502 in some zones/areas when the load alleviation is not performed (e.g., as shown in graph 508). This may cause catastrophic structural failure. Examples described in FIGS. 1-4 may bring the differential pressure of the structure within the pre-determined limit 502 (e.g., as shown in graph 506) based on zones.

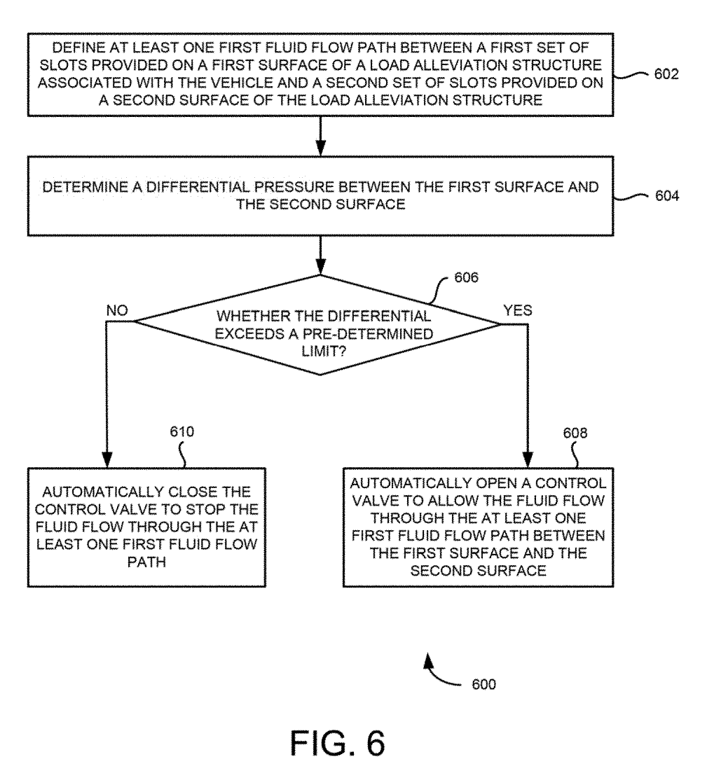

FIG. 6 is a flowchart of an example method 600 for controlling load of a structure. It should be understood the process depicted in FIG. 6 represents generalized illustrations, and that other processes may be added or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flowchart is not intended to limit the implementation of the present application, but rather the flow charts illustrate functional information to design/fabricate circuits, generate machine-readable instructions, or use a combination of hardware and machine-readable instructions to perform the illustrated processes.

At 602, at least one first fluid flow path may be defined/forming between a first set of slots provided on a first surface of a structure and a second set of slots provided on a second surface of the structure. The second surface may face opposite to the first surface. Example structure may include, but not limited to, aerodynamic component of a vehicle such as a wing, spoiler, stabilizing surface, control surface of the aircraft, a high-rise structure such as a tower, sky-scraper, other aerodynamic component such as a blade of a windmill, a column or pillar of partly, completely immersed structures such as an oil rig, a spoiler for a car, and the like. Example vehicle may include an aircraft, a missile, a watercraft, a car, and a spacecraft.

At 604, a differential pressure between the first surface and the second surface may be determined during operation (e.g., operation of the vehicle, movement of the structure or when the structure is subjected to fluid flow). In one example, the differential pressure between the first surface and the second surface may be determined using a pressure sensor installed in the structure.

Further, fluid flow is controlled through the at least one first fluid flow path based on the differential pressure as shown in blocks 606-610. At 606, a check is made to determine whether the differential pressure between the first surface and the second surface exceeds a pre-determined limit that is pre-programmed in the pressure sensor. At 608, a control valve may be automatically opened to allow the fluid flow through the at least one first fluid flow path between the first surface and the second surface when the differential pressure between the first surface and the second surface exceeds the pre-determined limit. This may reduce pressure difference between the first surface and the second surface. Example control valve may be a control flap to open/close the first set of slots and the second set of slots.

At 610, the control valve is automatically closed to stop the fluid flow through the at least one first fluid flow path when the differential pressure between the first surface and the second surface falls below the pre-determined limit. In one example, the fluid flow through the at least one first fluid flow path may be controlled as a function of the differential pressure with respect to the pre-determined limit.

In one example, the differential pressure between the first surface and the second surface may be determined by a pressure sensor at the first set of slots and the second set of slots. In this case, the first set of slots and the second set of slots may be used for pressure sensing and controlling.

In another example, a first set of non-pressure sensing slots may be provided substantially adjacent to the first set of slots in the first surface. Further, a second set of non-pressure sensing slots may be provided substantially adjacent to the second set of slots in the second surface. At least one second fluid flow path is defined/provided between the first set of non-pressure sensing slots and the second set of non-pressure sensing slots. The first set of non-pressure sensing slots and the second set of non-pressure sensing slots may not be associated with any pressure sensor. In this case, fluid flow through the at least one second fluid flow path may be controlled based on the differential pressure measured at the first set of slots and the second set of slots.

The surface (e.g., of a wing) may be divided span wise into zones, such that each zone has micro-slots which are managed by a single pressure-sensor with a threshold that is tuned specifically for that zone. Each zone may be controlled independently using the method described in FIG. 6 and the pressure across the span (and hence the loading) can thus be managed as per the needs of the design to reduce bending moment on roots of the wing during the gust.

It may be noted that the above-described examples of the present solution are for the purpose of illustration only. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A structure in a fluid flow, comprises:
a first surface defining at least one slot;
a second surface facing opposite to the first surface and defining at least one slot;
at least one first channel defining a fluid flow path between the at least one slot in the first surface and the at least one slot in the second surface;
a pressure sensing and control unit coupled to the at least one first channel, wherein the pressure sensing and control unit comprises:
a pressure sensor to determine a differential pressure between the first surface and the second surface; and
a controller to control fluid flow through the at least one first channel based on the differential pressure.

2. The structure of claim 1, wherein the controller is to:
determine whether the differential pressure between the first surface and the second surface exceeds a pre-determined limit;
when the differential pressure between the first surface and the second surface exceeds the pre-determined limit, instruct a control valve to allow the fluid flow through the at least one first channel between the first surface and the second surface, thereby reducing pressure difference between the first surface and the second surface; and
when the differential pressure between the first surface and the second surface falls below the pre-determined limit, instruct the control valve to stop the fluid flow through the at least one first channel.

3. The structure of claim 2, wherein the controller is to control the fluid flow through the at least one first channel as a function of the differential pressure with respect to the pre-determined limit.

4. The structure of claim 2, wherein the control valve is a control flap to open/close the at least one slot on each of the first surface and the second surface.

5. The structure of claim 1, wherein the pressure sensor is to determine the differential pressure between the first surface and the second surface using the at least one slot defined in each of the first surface and the second surface.

6. The structure of claim 5, further comprising:
at least one non-pressure sensing slot defined substantially adjacent to the at least one slot in the first surface and the at least one slot in the second surface; and
at least one second channel formed between the at least one non-pressure sensing slot defined in the first surface and the at least one non-pressure sensing slot defined in the second surface, wherein the controller is coupled to the at least one second channel, and wherein the controller is to instruct the control valve to control fluid flow through the at least one second channel based on the differential pressure measured at the at least one slot defined in each of the first surface and the second surface.

7. The structure of claim 1, wherein the at least one first channel is defined between the at least one slot in the first surface and the at least one slot in the second surface within the structure, and wherein the at least one slot in the first surface and the at least one slot in the second surface are positioned in line with openings of the at least one first channel.

8. The structure of claim 1, wherein at least a part of the structure is divided into a plurality of zones, wherein the plurality of zones comprises:
a plurality of sensors, with each sensor to determine differential pressure between the first surface and the second surface of a corresponding zone; and
a plurality of controllers, with each controller to control fluid flow through channels defined in the corresponding zone based on the differential pressure at the corresponding zone.

9. A method for controlling load of a structure in a fluid flow, comprising:
defining at least one first fluid flow path between a first set of slots provided on a first surface of a structure and a second set of slots provided on a second surface of the structure, the second surface facing opposite to the first surface;
determining a differential pressure between the first surface and the second surface; and
controlling fluid flow through the at least one first fluid flow path based on the differential pressure.

10. The method of claim 9, wherein the differential pressure between the first surface and the second surface is determined using a pressure sensor.

11. The method of claim 10, wherein controlling the fluid flow through the at least one fluid flow path based on the differential pressure, comprises:
determining whether the differential pressure between the first surface and the second surface exceeds a pre-determined limit that is pre-programmed in the pressure sensor;
when the differential pressure between the first surface and the second surface exceeds the pre-determined limit, automatically opening a control valve to allow the fluid flow through the at least one first fluid flow path between the first surface and the second surface, thereby reducing pressure difference between the first surface and the second surface; and
when the differential pressure between the first surface and the second surface falls below the pre-determined limit, automatically closing the control valve to stop the fluid flow through the at least one first fluid flow path.

12. The method of claim 11, wherein the fluid flow through the at least one first fluid flow path is controlled as a function of the differential pressure with respect to the pre-determined limit.

13. The method of claim 11, wherein the control valve is a control flap to open/close the first set of slots and the second set of slots.

14. The method of claim 10, wherein the differential pressure between the first surface and the second surface is determined by a pressure sensor at the first set of slots and the second set of slots.

15. The method of claim 9, further comprising:
providing a first set of non-pressure sensing slots substantially adjacent to the first set of slots in the first surface;
providing a second set of non-pressure sensing slots substantially adjacent to the second set of slots in the second surface;
defining at least one second fluid flow path between the first set of non-pressure sensing slots and the second set of non-pressure sensing slots; and
controlling fluid flow through the at least one second fluid flow path based on the differential pressure measured at the first set of slots and the second set of slots.

16. The method of claim 9, wherein the at least one first fluid flow path is defined between the first set of slots and the second set of slots within the structure, and wherein the first set of slots and the second set of slots are positioned in line with openings of the at least one first fluid flow path.

17. An aerodynamic component load alleviation system, comprising:
a wing divided into a plurality of zones along a span of the wing, wherein each zone comprises:
a top surface having a first set of slots distributed across a chord;
a bottom surface having a second set of slots distributed across the chord;
at least one first channel defining an air flow path between the first set of slots and the second set of slots;
a pressure sensor to determine a differential pressure between the top surface and the bottom surface during flight; and
a controller coupled to the pressure sensor, wherein the controller is to control air flow through the at least one first channel based on the differential pressure.

18. The aerodynamic component load alleviation system of claim 17, wherein the controller is to:
determine whether the differential pressure between the top surface and the bottom surface exceeds a pre-determined limit;
when the differential pressure between the top surface and the bottom surface exceeds the pre-determined limit, instruct a control valve to allow the air flow through the at least one first channel between the top surface and the bottom surface, thereby reducing pressure difference between the top surface and the bottom surface; and
when the differential pressure between the top surface and the bottom surface falls below the pre-determined limit, instruct the control valve to stop the air flow through the at least one first channel.

19. The aerodynamic component load alleviation system of claim 18, wherein the controller is to control the air flow through the at least one first channel as a function of the differential pressure with respect to the pre-determined limit.

20. The aerodynamic component load alleviation system of claim 18, wherein the pressure sensor is pre-programmed with the pre-determined limit that is tuned corresponding to each zone.

21. The aerodynamic component load alleviation system of claim 18, wherein the control valve is a control flap to open/close the first set of slots and the second set of slots.

22. The aerodynamic component load alleviation system of claim 17, wherein the pressure sensor is to determine the differential pressure between the top surface and the bottom surface at the first set of slots and the second set of slots.

23. The aerodynamic component load alleviation system of claim 17, wherein each zone further comprises:
a first set of non-pressure sensing slots defined substantially adjacent to the first set of slots on the top surface;
a second set of non-pressure sensing slots defined substantially adjacent to the second set of slots on the bottom surface; and
at least one second channel formed between the first set of non-pressure sensing slots and the second set of non-pressure sensing slots, wherein the controller is to control air flow through the at least one second channel based on the differential pressure determined between the first set of slots and the second set of slots.

24. The aerodynamic component load alleviation system of claim 23, wherein the at least one second channel is defined between the first set of non-pressure sensing slots on the top surface and the second set of non-pressure sensing slots on the bottom surface within the wing, and wherein the first set of non-pressure sensing slots and the second set of non-pressure sensing slots are positioned in line with openings of the at least one second channel.

25. The aerodynamic component load alleviation system of claim 17, wherein the at least one first channel is defined between the first set of slots on the top surface and the second set of slots on the bottom surface within the wing, and wherein the first set of slots and the second set of slots are positioned in line with openings of the at least one first channel.
